(19) United States
(12) Patent Application Publication
(10) Pub. No.: US 2019/0034757 A1
(43) Pub. Date: Jan. 31, 2019

(54) METHOD AND SYSTEM FOR ON-DEVICE IMAGE RECOGNITION

(71) Applicant: Henry Shu, Walnut, CA (US)

(72) Inventor: Henry Shu, Walnut, CA (US)

(21) Appl. No.: 16/051,424

(22) Filed: Jul. 31, 2018

Related U.S. Application Data
(60) Provisional application No. 62/539,192, filed on Jul. 31, 2017.

(51) Int. Cl. G06K 9/62; G06K 9/20; G06F 17/30; G06F 15/18; G06N 3/08

(52) U.S. Cl. CPC G06K 9/6202; G06K 9/2054; G06N 3/08; G06F 15/18; G06F 17/30256

(57) ABSTRACT

In one aspect, a method for real-time image recognition on a mobile communication device may include steps of receiving an image from the mobile communication device; analyzing the image and identifying one or more possible attributes in the image; storing the image and possible attributes in a database; selecting a first subset of attributes among the identified attributes through an artificial intelligence system that each attribute in the first subset having a confidence level greater than a threshold value; and recognizing the image by displaying each attribute in the first subset from the attribute with the highest confidence level. In one embodiment, the step of identifying one or more possible attributes in the image may include a step of using an artificial intelligence system trained by a plurality of images and attributes.

### CROSS-REFERENCE TO RELATED APPLICATIONS

This application claims priority under 35 U.S.C. § 119 (e) to U.S. Provisional Patent Application Ser. No. 62/539,192, filed on Jul. 31, 2017, the entire contents of which are hereby incorporated by reference.

### FIELD OF THE INVENTION

The present invention relates to a method and system for image recognition, and more particularly to a method and system for image recognition that can be completely performed on a mobile device without connecting to any external computing devices, like servers, cloud computing apparatus, etc.

### BACKGROUND OF THE INVENTION

With remarkable advances of computer technologies and increasing popularity of digital cameras and digital video cameras, it is common for an individual to possess a large database of digital images, and how to efficiently retrieve desired images from the image database becomes an increasingly important topic in computer vision.

Recognizing an image based on specific features is a task easily solved by the human eye and brain that has been trained to do so, but it is still not satisfactorily solved by computers. While the human brain is capable of image recognition, the human brain has a difficulty in memorizing large amounts of information, i.e. associating specific information related to large amount of images. The information attached to each image can vary between many kinds of multimedia information such as sound, video, images, and textual information and can be easily retrieved from a server if the corresponding image is matched. Still further, this problem, particularly for computers, is made more difficult since the associated information can be dynamic and change for the same image under different conditions and with movement. In addition, the existing computer-based image recognition systems require large amounts of data, long processing times, large non-portable devices and cannot function in real time or close to real time.

Advancements in cellular communication technology and mobile communication devices, such as the integration of camera and video recording technology onto such communication devices, incorporation of e-mail and short messaging services into cellular communication networks, and the like, have added greater flexibility, processing power, and communication capabilities to already ubiquitous mobile communication devices. However, due to the size of mobile communication devices, the computing capability thereof is still not comparable with computers. As stated above, computer-based image recognition systems require large amounts of data, long processing times and large non-portable devices, which may be difficult or nearly impossible to accomplish on a mobile communication device.

Therefore, there remains a need for a new and improved image recognition system with high computing efficiency so the system can be run on a mobile communication device without connecting to any external computing devices, such as servers, cloud computing apparatus, etc.

### SUMMARY OF THE INVENTION

It is an object of the present invention to provide an on-device image recognition system that is purely software-based without connecting to any external computing devices, like servers, cloud computing apparatus, etc.

It is another object of the present invention to provide an on-device image recognition system having an attribute identification system that can be trained by an artificial intelligence system.

It is still another object of the present invention to provide an on-device image recognition system that only uses four percent (4%) of the RAM, so the user can make a phone call while the mobile phone is conducting image recognition.

It is a further object of the present invention to provide an on-device image recognition system that not only saves the user's time and network bandwidth, but also eliminates all kinds of privacy issues from granting a remote access to the user's personal device.

It is a further object of the present invention to provide an on-device image recognition system that can be applied to entomologists, automatic photo organization on smartphones, educational games, adult content removal, virtual reality, blind assistance, etc.

In one aspect, a method for real-time image recognition on a mobile communication device may include steps of receiving an image from the mobile communication device; analyzing the image and identifying one or more possible attributes in the image; selecting a first subset of attributes among the identified attributes through an artificial intelligence system that each attribute in the first subset having a confidence level greater than a threshold value; and recognizing the image by displaying each attribute in the first subset from the attribute with the highest confidence level.

In one embodiment, the step of identifying one or more possible attributes in the image may include a step of using an artificial intelligence system trained by a plurality of images and attributes. In another embodiment, the step of analyzing the image is through image pixel analysis.

### BRIEF DESCRIPTION OF THE DRAWINGS

FIG. 1 is a block diagram of the attribute identification system on the mobile communication device for image recognition in the present invention.

FIG. 2 illustrates an example for the instant and on-device image recognition perform on the mobile communication device in the present invention.

FIG. 3 illustrates another example for the instant and on-device image recognition perform on the mobile communication device in the present invention.

FIG. 4 illustrates another example for the instant and on-device image recognition perform on the mobile communication device in the present invention.

FIG. 5 illustrates a further example for the instant and on-device image recognition perform on the mobile communication device in the present invention.

FIG. 6 illustrates a method for real-time image recognition on a mobile communication device in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

As stated above, computer-based image recognition systems require large amounts of data, long processing times and large non-portable devices, which may not be performed on a mobile communication device such as a cellular phone that has limited computation capability. However, through artificial intelligence, the computation efficiency can be significantly enhanced and using the mobile communication device for real-time image recognition without connecting to external servers or computing devices may be achievable.

Accordingly, the embodiments described herein provide a method and system for image recognition that may use artificial intelligence (e.g., machine learning techniques (MLTs), such as deep belief networks (DBN) and convolutional neural nets (CNN)) to recognize the image captured or provided by the mobile device. DBNs may have the following characteristics: a generative graphical model that includes multiple layers of latent variables (e.g., hidden units) and connections between the layers, but not connections between units within each layer; and a system that, when trained on a set of examples in an unsupervised way, can learn to probabilistically reconstruct its inputs, where the layers act as feature detectors on the inputs, and that, when trained on a set of examples in a supervised way, can perform classification. CNNs may have the following characteristics: a feed-forward artificial neural network where the individual neurons of the CNN are tiled in a manner such that the neurons respond to overlapping regions in a visual field; a neural network that includes multiple layers of small neuron collections that look at small portions of an input image, where the results are tiled to overlap and provide a better representation of the input image; and a neural network that can be used for image recognition. The DBNs or CNNs may be trained on a set of images that depict one or more items. Some images may be annotated such that a type of item depicted in the image, attributes, and/or locations of the attributes are indicated in the image. Other images may include no annotations. Using these images, the DBNs or CNNs may be trained to identify different items present in an image as well as the attributes of those items when presented with the image. For simplicity, the image recognition system is described herein with reference to MLTs; however, this is not meant to be limiting. The image recognition system described herein can be implemented with any artificial intelligence, such as with CNNs or a combination of DBNs and CNNs.

The image recognition system may use a single, general MLT to recognize an image. The image recognition system may also use a plurality of MLTs to recognize an image. For example, the image recognition system may pass an image through a categorizer MILT. The categorizer MLT may be trained using a plurality of images and may identify one or more types of image segments depicted in the image. The categorizer MLT may also provide a level of confidence that the segment depicted in the image is actually the image segment being identified. Based on the identified segments, the image recognition system may select one or more MLTs that are associated with the identified type of item. For example, one or more MLTs may be trained specifically using images that depict a specific segment and/or using images that are annotated to indicate a single attribute in a single segment. The one or more MLTs associated with the identified segments may then identify attributes of the segments depicted in the image.

In some embodiments, the categorizer MLT identifies a plurality of possible types of segments that may be depicted in the image, where each identified possibility is associated with a confidence level. For example, the categorizer MLT may determine that the image depicts a first type of image segment (e.g., a supermarket) with a first confidence level (e.g., 50%) and may determine that the image depicts a second type of image segment (e.g., a candy store) with a second confidence level (e.g., 30%). The categorizer MLT may select the type of image segment that has the highest confidence level and select one or more MLTs that are associated with the type of image segment that has the highest confidence level to identify attributes. Alternatively, the categorizer MLT may select one or more MLTs associated with one or more identified types of image segment (regardless of confidence level) and use the selected MLTs to identify attributes. For example, the selected MLTs for each possible type of image segment may run in parallel to identify attributes.

The image recognition system may identify attributes of the image in a variety of contexts. For example, upon receiving the image, the image recognition system may send the image to the general MLT, and the general MLT may produce a list of possible attributes in the image. Alternatively, the image recognition system may send the image to the categorizer MLT, and the categorizer MLT may identify one or more image segments depicted in the image. Each attribute in the list of possible attributes of the image segments in the image may be associated with a confidence level. The image recognition system may select attributes from the list that have a confidence level over a threshold value. For example, the image recognition system may select attributes from the list that have a confidence level over 90%. The attributes that have a confidence level over the threshold value may be presented to the user as suggested attributes to add to the description of the image or image segment. In some embodiments, the user can provide feedback to the image recognition system identifying which suggested attributes are correct and which suggested attributes are incorrect. Such feedback may be used to update the training of the general MLT, the categorizer MLT, and/or the MLTs specific to the image segment.

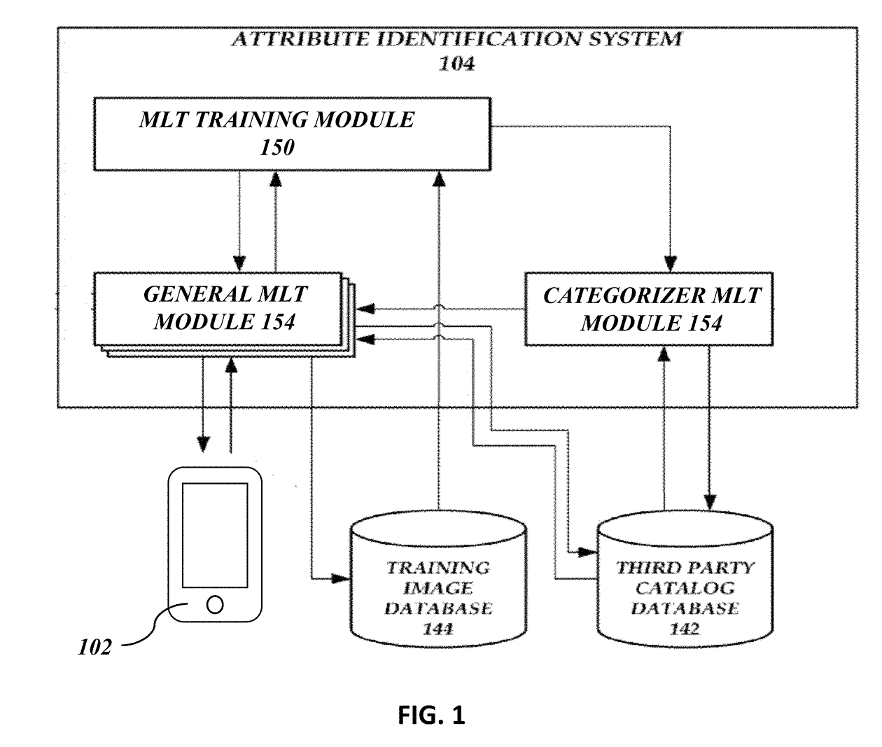

In one aspect, an image recognition system 100 in the present invention may include an attribute identification system 104 as shown in FIG. 1A that can be used to recognize the image by identifying the attributes of the image. The system 104 may perform two main operations: conduct machine learning with machine learning techniques (MLTs) and identify attributes in images.

To conduct machine learning, in an embodiment, a training image database 144 stores images that can be used to train one or more MLTs. Some of the images in the training image database 144 may include annotations. For example, an annotation may be a polygonal boundary laid over a portion of an image that is associated with a string value that identifies a feature or attribute of at least one image segment depicted in the image. Other images in the training image database 144 may not include annotations.

The training image database 144 may organize images such that they are associated with attributes of images or the like. The training image database 144 may also include positive and negative samples associated with an attribute of an image or at least an image segment. For example, a positive sample may be an image that includes an annotation identifying a specific attribute in the image. A negative sample may be an image that includes an annotation stating that an identified portion of the image is not or does not include the specific attribute.

The training image database 144 may be located external to the attribute identification system 104, such as on a separate system or server. The attribute identification system 104 may include a MLT training module 150 that trains one or more MLTs based on the images stored in the training image database 144. The attribute identification system 104 may include a categorizer MLT module 152, and one or more general MLT modules 154. The general MLT 154 may be used to recognize attributes in any type of images. The categorizer MLT module 152 may be used to identify a specific type of image segment depicted in an image. Thus, the MLT training module 150 may train the general MLT module 154 as well as the categorizer MLT module 152.

In another embodiment, the MLT training module 150 trains the general MLT using some or all images stored in the training image database 144. The MLT training module 150 may train the categorizer MLT in the categorizer MLT module 152 using a portion of the images stored in the training image database 144. For example, the portion may include a wide variety of images, but not images that specifically identify attributes for specific images or image segments. In some embodiments, the MLT training module 150 further trains the MLTs by providing a series of images and requesting the MLTs to identify attributes. The results may be reviewed (for example, by an administrator) and feedback regarding the results may be provided to the MLT training module 150. The MLT training module 150 may use the feedback to further refine the MLTs.

To identify attributes in the images, in one embodiment, a third party catalog database 142 stores listings of images that are available for viewing in a network-accessible system. The listings may include one or more images, and a name or type of images for which the listings is generated. The third party catalog database 142 may be located external to the attribute identification system 104 and/or the training image database 144, such as on a separate system or server. The third party catalog database 142 may be owned by the same entity as the entity that owns the network-accessible system and/or the attribute identification system 104, may be owned by an entity related to the entity that owns the network-accessible system and/or the attribute identification system 104, or may be owned by an entity different from the entity that owns the network-accessible system and/or the attribute identification system 104. However, in the present invention, the third party catalog database 142 is purely for training purposes. When the mobile device in the present is used, it is unnecessary to connect to any external network to recognize images.

The attribute identification system 104 may operate in one of a plurality of scenarios. In a first scenario, the attribute identification system 104, and specifically the categorizer MLT module 152, may receive an image from a user device 102 and the categorizer MLT module 152 may use a categorizer MLT to identify an image segment or an image. The categorizer MLT may also provide a level of confidence for the identified image.

In one embodiment, the identified attributes are incorporated without any feedback from the user. In another embodiment, the user associated with the user device 102 may provide feedback on the identified attributes. For example, the user may verify that the identified attributes or suggested attribute revisions are accurate. The user may also provide additional attributes that were not included in the identified attributes or correct any recommended revisions to the attributes that are incorrect. The feedback may be provided to the MLT training module 150 such that the training of the categorizer MLT and/or the general MLT that can be updated. Alternatively, the feedback (e.g., the annotated image) may be stored in the training image database 144. Once the user has provided feedback, the recognition results may be updated to incorporate the feedback.

It is important to note the attribute identification system 104 can be incorporated in the mobile communication device in the present invention to perform image recognition. And if the system 104 is well and properly trained as described above, the mobile communication device can perform a real-time image recognition thereon.

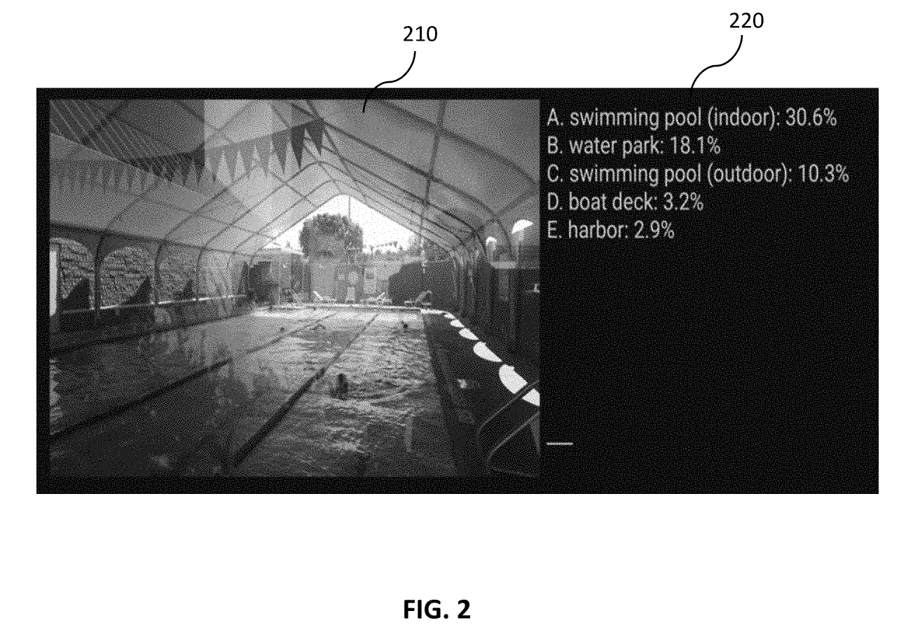

As shown in FIG. 2, an image 210 is taken by the mobile device 102 and can be instantly analyzed on the mobile device 102 through the attribute identification system 104. More specifically, upon receiving the image 210, the attribute identification system 104 is configured to generate one or more attributes to identify the image based on the training received. Furthermore, each attribute is assigned with a confidence level that can be converted to a percentage regarding the attribute of the image, which can be displayed from the high to low. For example, the image 210 is most likely an indoor swimming pool, and the trained attribute identification system 104 on the mobile device 102 can quickly recognize the image 210 with a list 220 of possible attributes (indoor swimming pool, water park, outdoor swimming pool . . . ) with respective confidence level (30.6%, 18.1%, 10.3% . . . ).

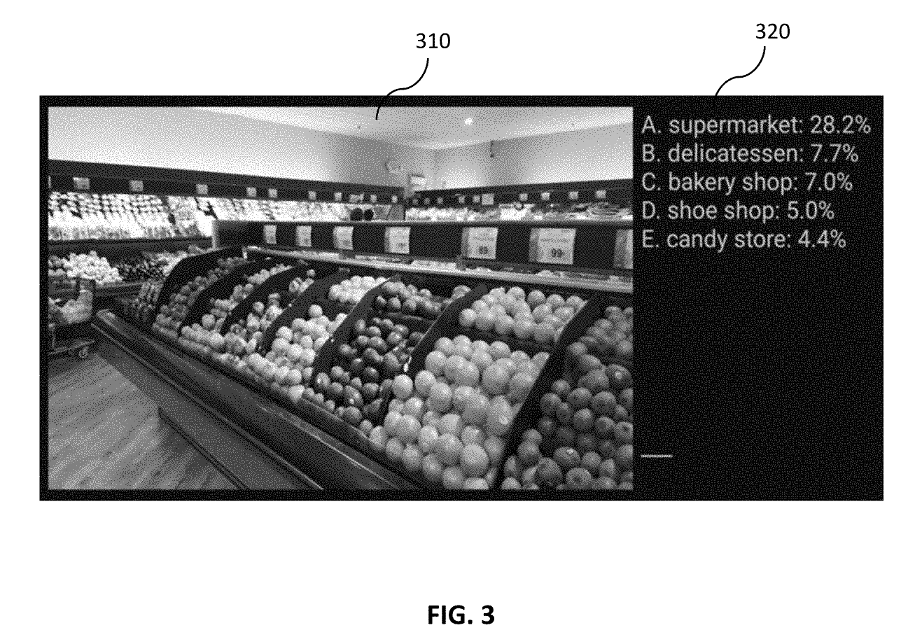

Similarly, as shown in FIG. 3, an image 310 is taken by the mobile device 102 and can be instantly analyzed on the mobile device 102 through the attribute identification system 104. More specifically, upon receiving the image 310, the attribute identification system 104 is configured to generate one or more attributes to identify the image based on the training received. Furthermore, each attribute is assigned with a confidence level that can be converted to a percentage regarding the attribute of the image, which can be displayed from the high to low. For example, the image 310 is most likely a supermarket, and the trained attribute identification system 104 on the mobile device 102 can quickly recognize the image 310 with a list 320 of possible attributes (supermarket, delicatessen, bakery shop . . . ) with respective confidence level (28.2%, 7.7%, 7.0% . . . ).

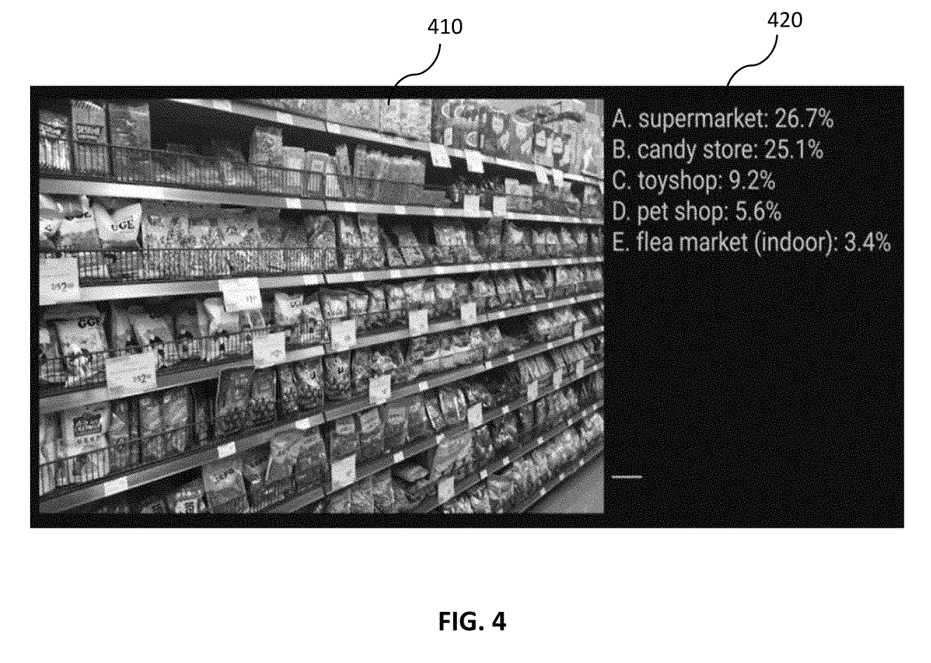

It is noted that the attribute identification system 104 on the mobile device 102 can be trained to identify two different images that belong to the same attribute. For example, as shown in FIG. 4, an image 410 shows another section of the supermarket and the items on the shelf are completely different from the items in FIG. 3. However, through the trained attribute identification system 104, the mobile device 102 can still successfully recognize the image 410 as a supermarket (26.7%), the highest confidence level in the attribution list 420. It is interesting to note that the “candy store” has the second highest confidence level (25.1%), perhaps due to the arrangement of the small pack items that resemble candy packages.

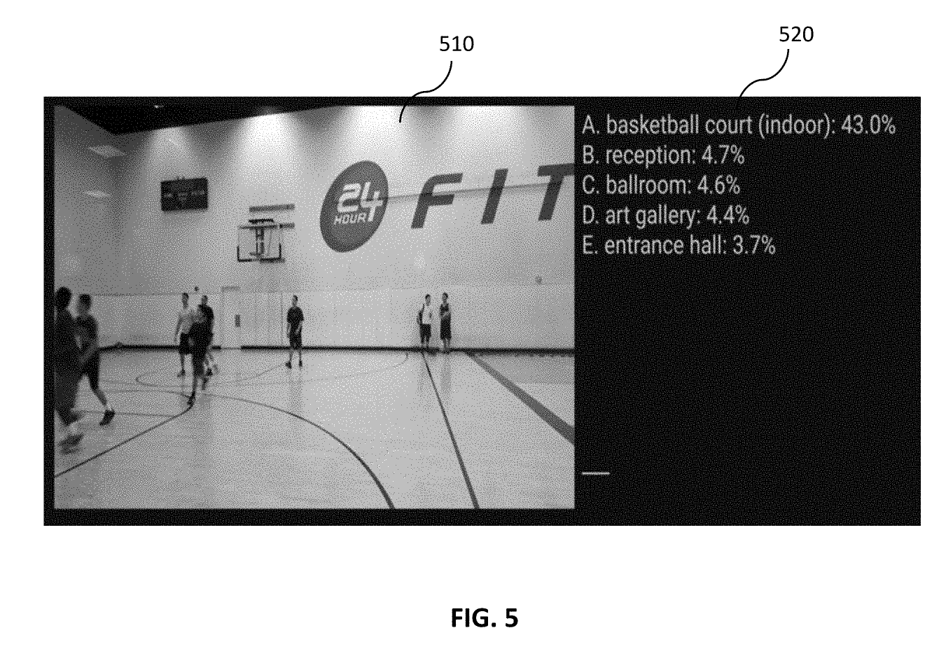

Another successful image recognition on the mobile communication device 102 in the present invention is shown on FIG. 5. An image 510 is most likely taken at an indoor basketball court and upon receiving the image 510, the attribute identification system 104 is configured to generate one or more attributes to identify the image based on the training received. Furthermore, each attribute is assigned with a confidence level that can be converted to a percentage regarding the attribute of the image, which can be displayed as a list 520 from high to low: indoor basketball court (43.0%), reception (4.7%), ballroom (4.6%) as shown in FIG. 4.

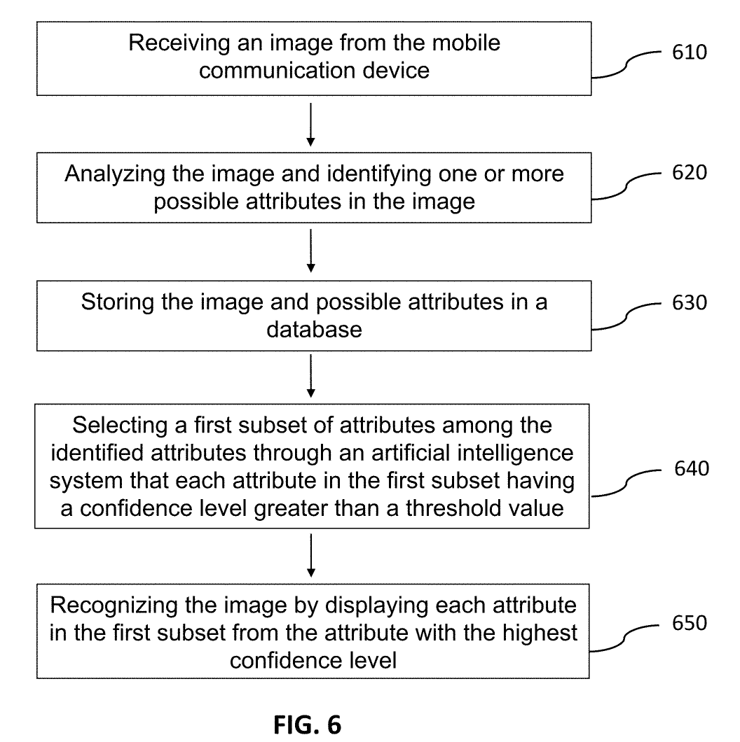

In another aspect, as shown in FIG. 6, a method for real-time image recognition on a mobile communication device may include steps of receiving an image from the mobile communication device 610; analyzing the image and identifying one or more possible attributes in the image 620; storing the image and possible attributes in a database 630; selecting a first subset of attributes among the identified attributes through an artificial intelligence system that each attribute in the first subset having a confidence level greater than a threshold value 640; and recognizing the image by displaying each attribute in the first subset from the attribute with the highest confidence level 650.

In one embodiment, the step of identifying one or more possible attributes in the image 620 may include a step of using an artificial intelligence system trained by a plurality of images and attributes 621. In another embodiment, the step of analyzing the image is through image pixel analysis. In a further embodiment, the method for real-time image recognition on a mobile communication device may further include a step of updating the database to include at least one attribute in the first subset of attributes that is not included in the attributes associated with the image 660. In still a further embodiment, the method for real-time image recognition on a mobile communication device may further include transmitting, to the mobile communication device, an identification of at least one attributes in the first subset of attributes that is not included in the attributes associated with the image 670.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A method for real-time image recognition on a mobile communication device may include steps of:
receiving an image from the mobile communication device;
analyzing the image and identifying one or more possible attributes in the image;
storing the image and possible attributes in a database;
selecting a first subset of attributes among the identified attributes through an artificial intelligence system that each attribute in the first subset having a confidence level greater than a threshold value; and
recognizing the image by displaying each attribute in the first subset from the attribute with the highest confidence level.

2. The method for real-time image recognition on a mobile communication device of claim 1, wherein the step of identifying one or more possible attributes in the image includes a step of using an artificial intelligence system trained by a plurality of images and attributes.

3. The method for real-time image recognition on a mobile communication device of claim 1, wherein the images are analyzed through pixel analysis.

4. The method for real-time image recognition on a mobile communication device of claim 1, further including a step of updating the database to include at least one attribute in the first subset of attributes that is not included in the attributes associated with the image.

5. The method for real-time image recognition on a mobile communication device of claim 1, further comprising transmitting, to the mobile communication device, an identification of at least one attributes in the first subset of attributes that is not included in the attributes associated with the image.
